(19) United States
(12) Patent Application Publication
(10) Pub. No.: US 2014/0271413 A1
(43) Pub. Date: Sep. 18, 2014

(54) Reactor Vessel for Complexecelle Formation

(71) Applicant: Perfect Lithium Corp., (US)

(72) Inventor: Teresita Frianeza-Kullberg, Gastonia, NC (US)

(73) Assignee: Perfect Lithium Corp., Vancouver (CA)

(21) Appl. No.: 13/839,110

(22) Filed: Mar. 15, 2013

(51) Int. Cl. B01J 10/00

(52) U.S. Cl. CPC B01J 10/002
USPC 422/606; 422/225; 422/228

(57) ABSTRACT

A reactor vessel for complexecelle formation is described. The reactor vessel has a vessel for containing a first reactant wherein the vessel comprises an open top. A lid is provided for attachment to the vessel which is adapted for sealing the open top. An impeller shaft extends through the lid and into the vessel wherein the impeller comprises at least one stirrer blade extending from the impeller shaft and the impeller shaft is adapted to rotate in the first reactant. A gas diffuser extends into the first reactant. A gas source is provided which is capable of providing gas to the gas diffuser for dispersing the gas into the first reactant. The rotating impeller shaft and gas source are capable of simultaneously acting to form bubble surfaces of the first reactant. A metering device is provided for introducing a second reactant to the vessel onto the bubble surfaces.

### BACKGROUND

The present invention is related to an improved reactor design. More specifically, the present invention is relate to a reactor design for complexecelle formation.

Complexecelle formation is a technique wherein a first solution comprising a first reactant is frothed, by the combination of gas flow and agitation, to create bubbles which rise to the surface. A second solution comprising a second reactant is then metered into the reactor whereby the first and second reactant form reaction intermediates and products on the surface of the bubbles. Reactant migration is limited by the bubble formation thereby allowing for accurate control of reaction kinetics by controlling the bubble size and rate of addition of the second reactant.

The use of complexecelle formation allows for the preparation of many known materials with a level of both particle size and particle size distribution which has heretofore been difficult to obtain. Those of skill in the art have been limited in their ability to advance the art of complexecelle formation due to the lack of suitable reactor vessels for this specific process.

Provided herein is a reactor vessel specifically designed to allow for complexecelle formation.

### SUMMARY OF THE INVENTION

It is an object of the invention to provide an improved reactor vessel and reactor system.

It is another object of the invention to provide a reactor vessel and reactor system which is particularly well suited for frothing a solution for use in the formation of complexecelles.

These and other advantages, as will be realized, are provided in a reactor vessel for complexecelle formation. The reactor vessel has a vessel for containing a first reactant wherein the vessel comprises an open top. A lid is provided for attachment to the vessel which is adapted for sealing the open top. An impeller shaft extends through the lid and into the vessel wherein the impeller comprises at least one stirrer blade extending from the impeller shaft and the impeller shaft is adapted to rotate in the first reactant. A gas diffuser extends into the first reactant. A gas source is provided which is capable of providing gas to the gas diffuser for dispersing the gas into the first reactant. The rotating impeller shaft and gas source are capable of simultaneously acting to form bubble surfaces of the first reactant. A metering device is provided for introducing a second reactant to the vessel onto the bubble surfaces.

### FIGURES

FIG. 1 is an exploded schematic perspective view of an embodiment of the invention.

FIG. 2 is a cross-sectional schematic view of an embodiment of the invention.

FIG. 3 is a cross-sectional schematic view of an embodiment of the invention.

FIG. 4 is a cross-sectional schematic view of an embodiment of the invention.

FIG. 5 is a cross-sectional schematic view of an embodiment of the invention.

FIGS. 6a and 6b are partial schematic views of an embodiment of the invention.

FIG. 7 is a top schematic view of an embodiment of the invention.

FIG. 8-12 are schematic bottom views of embodiments of the invention.

FIG. 13-18 are schematic bottom views of embodiments of the invention.

### DESCRIPTION

The instant invention is specific to a reactor vessel and reactor system which is particularly suited for complexecelle formation. More specifically, the present invention is related to a reactor vessel and reactor system which provides a frothed solution, comprising a large number of bubbles, wherein the bubbles rise to the surface and a method of introduction of a second reactant to form complexecelles on the surface of the bubbles.

The invention will be described with reference to the various figures which form an integral non-limiting component of the disclosure. Throughout the disclosure similar elements will be numbered accordingly.

An embodiment of the invention is illustrated in FIG. 1 wherein a reactor, generally represented at 10, is illustrated in partial exploded schematic view. The reactor comprises a vessel, 12, with a lid, 14, and preferably a seal, 16, such as a o-ring, there between. The lid and vessel are reversible secured one to the other, as would be realized in art, to form a closed container such that material moves into and out of the closed container in a controlled manner as will be more fully described. Baffles, 18, which may be integral to the vessel or a separate component inserted into the vessel, facilitate mixing by inhibiting vortex and eddy formation. An impeller shaft, 20, extends through the lid and into the vessel. The impeller shaft, 20, may comprise a collar, 22, to fix the length of impeller shaft extension into the vessel. On the lower end of the impeller shaft, defined for convenience as the end extending into the vessel, is at least one, and preferably a multiplicity of stirrer blades, 24. In one embodiment the stirrer blades are rotationally fixed and in another embodiment the blades rotate on an axis which is independent of the axis of the impeller shaft. The upper end of the impeller shaft is adapted for coupling with some form of a motor to rotate the impeller shaft on its axis. Gas diffusers, 26, extend into the reactor. Gas diffusers provide a source of flowing gas which is introduced into a solution, not shown in this view, thereby causing gas bubbles to form within the solution. The rotating impeller shaft with stirrer blades thereon persuade the gas bubbles to migrate to the surface thereby providing a constant source of bubble surfaces at the upper interface of the solution within the vessel. In FIG. 1 the gas diffusers are represented as a hollow tube with orifices therein. Gas is introduced to the upper end of the tube and it exits the orifices. The orifices may all be the same size or the size may vary to control the depth and rate of bubble formation. A collar, 22, may be employed to limit the extension of the gas diffuser into the vessel. Metering devices, 28, allow for the controlled introduction of a second solution into the vessel, above the level of bubbles, wherein the reactant in the second solution can react with the first reactant on the bubble surface. In the embodiment of FIG. 1 the metering device is a hollow tube fitted with a solution diffuser, 30, on the bottom thereof wherein the solution diffuser disperses the second solution across a wider area of the vessel thereby improving control of the reaction. The solution diffuser of the embodiment in FIG. 1 comprises a bladed disk which may be stationary or rotating. Additional ports, 32, allow for the measurement control of various properties such as pH, temperature and the like. At least one port allows excess gas to exit the reactor.

An embodiment of the invention is illustrated in schematic cross-sectional view in FIG. 2. The gas diffuser, 26, is represented as a continuous tube exiting through the lid on each end with orifices in the tube wherein the tube essentially mirrors the contour of the vessel. This configuration allows for a large volume of gas to be introduced throughout the solution. Bubbles, 34, at the surface of the solution receive the second reactant, 36, on the bubble surface and complexecelles form thereon. A secondary reactor, 38, allows overflow to be collected and metered back into the vessel by a pump, 40, through a valve, 42. Alternatively, the pump can circulate solution into and out of the vessel for testing purposes, to make up for volume, additional stirring, etc. In another embodiment the secondary reactor can be used to harvest reaction product thereby providing for continuous or near continuous operation. A motor, 21, rotates the impeller shaft.

An embodiment of the invention is illustrated in cross-sectional schematic view in FIG. 3. In FIG. 3, the vessel comprises an interior lining, 44, which functions as a gas diffuser. Gas is introduced at a fitting, 46, and exits orifices in the interior lining. In practice it is preferable to begin gas flow prior to adding the first reactant to the vessel thereby avoiding first reactant from entering the interior lining.

An embodiment of the invention is illustrated in cross-sectional schematic view in FIG. 4. In FIG. 4, gas is introduced at inlets, 46, which are integral to the recirculating ports, 48.

An embodiment of the invention is illustrated in cross-sectional schematic view in FIG. 5. In FIG. 5, the gas diffuser, 50, is integral to a hollow impeller shaft, 52. Gas is passed into, preferably, the top of the hollow impeller shaft and exits preferably near the bottom of the impeller shaft. The impeller shaft may include orifices therein or a portion of the impeller shaft may be, or be attached to, a diffuser component such as a porous material such as a porous ceramic. A particular advantage of the embodiment of FIG. 5 is the close proximity of bubble formation and agitation thereby providing smaller, more diffuse bubbles. Two injectors, 54 and 56, allow for introduction of the second solution or an additional reactant interchangeably. A spray injector, 54, provides a radially distributed spray of reactant. A jet injector, 56 provides for a controlled jet of reactant.

An embodiment of a stirring blade is illustrated in schematic partial view in FIGS. 6a and 6b. The stirring blade comprises a core, 60, which preferably defines the shape of the blade with a coiled loop around the core. The core may be solid or hollow. The coiled loop increases the agitation caused by the stirring blade. In the embodiment illustrated in FIGS. 6a and 6b the stirring blade is attached to the impeller shaft by a rod, 64, and the stirring blade preferably rotates such that a plane containing the stirring blade is not continuously perpendicular to an axis of rotation of the impeller shaft. FIGS. 13-18 illustrate various configurations of stirring blades on an impeller shaft with preferably a multiplicity of stirring blades thereon wherein at least one stirring blade rotates on an axis which is not parallel, and is preferably perpendicular, to the impeller shaft. FIGS. 13, 14 and 16 illustrate three stirring blades mounted to the impeller shaft on a common plane. FIG. 17 illustrates four impeller blades all mounted on a common plane and FIGS. 15 and 18 illustrate at least one set of impeller blades mounted on separate planes wherein a plane is perpendicular to the impeller blade. Though not illustrated each impeller blade illustrated in FIGS. 13-18 may further comprise a coiled loop.

An embodiment of the invention is illustrated in FIG. 12 wherein the stirrer blade rotates in a plane perpendicular to the impeller blade. The impeller blade may be trigonal, rectangular, polygonal, round, oval or obround and may have cross-braces as illustrated in FIGS. 7-11. At least the outer frame, which defines the overall geometry preferably comprises coiled loop. The cross-braces preferably also comprise coiled loops.

Other stirrer blades which are suitable for demonstration of the invention include propeller, such as three blade propellers, turbine and axial propellers particularly with a large pitch such as 45°; dispersion blades, high shear radial flow impellers, folding impellers, high shear dispersing impellers, two blade impellers, high viscosity impellers, four blade impellers, paddle impellers, and high efficiencies propellers as described in Perry Handbook of Chemical Engineering. The impeller may have a ring guard.

The invention has been described with reference to the preferred embodiments without limit thereto. One of skill in the art would realize additional embodiments and improvements which are not specifically set forth herein but which are within the scope of the invention as more specifically set forth in the claims appended hereto.

1. A reactor vessel for complexecelle formation comprising:
a vessel for containing a first reactant wherein said vessel comprises an open top;
a lid for attachment to said vessel adapted for sealing said open top;
an impeller shaft extending through said lid into said vessel wherein said impeller comprises at least one stirrer blade extending from said impeller shaft and wherein said impeller shaft is adapted to rotate in said first reactant;
a gas diffuser extending into said first reactant;
a gas source capable of providing gas to said gas diffuser for dispersing said gas into said first reactant;
wherein said rotating impeller shaft and said gas source are capable of simultaneously acting to form bubble surfaces of said first reactant; and
a metering device for introducing a second reactant to said vessel onto said bubble surfaces.

2. The reactor vessel for complexecelle formation of claim 1 wherein said at least one stirrer blade comprises a core and coiled loops around said core.

3. The reactor vessel for complexecelle formation of claim 2 wherein said at least one stirrer blade comprises a cross-brace.

4. The reactor vessel for complexecelle formation of claim 1 wherein said gas diffuser comprise a tube.

5. The reactor vessel for complexecelle formation of claim 1 wherein said gas diffuser is an inner lining of said vessel.

6. The reactor vessel for complexecelle formation of claim 1 wherein said gas diffuser is integral to said impeller shaft.

7. The reactor vessel for complexecelle formation of claim 1 further comprising a secondary reactor adapted to exchange reactant with said vessel.

8. The reactor vessel for complexecelle formation of claim 1 wherein said metering device sprays said second reactant into said vessel.

9. The reactor vessel for complexecelle formation of claim 8 wherein said metering device is a solution diffuser

9. The reactor vessel for complexecelle formation of claim 8 wherein said solution diffuser is selected from a spray injector capable of providing a radially distributed spray of reactant and a jet injector capable of providing a controlled jet of reactant.

10. The reactor vessel for complexecelle formation of claim 1 wherein said vessel further comprises baffles.

11. The reactor vessel for complexecelle formation of claim 1 wherein said stirrer blade has a shape selected from the group consisting of trigonal, rectangular, polygonal, round, oval and obround.

12. The reactor vessel for complexecelle formation of claim 11 wherein said stirrer blade further comprises cross-braces.

13. The reactor vessel for complexecelle formation of claim 12 wherein said stirrer blade further comprises coiled loops.

14. The reactor vessel for complexecelle formation of claim 11 wherein said stirrer blade further comprises coiled loops.

15. The reactor vessel for complexecelle formation of claim 1 wherein said stirrer blades rotate on an axis which is not co-linear with rotation of said impeller shaft.

16. The reactor vessel for complexecelle formation of claim 1 wherein said impeller blade comprises multiple stirrer blades.

17. The reactor vessel for complexecelle formation of claim 16 wherein at least two said stirrer blades are mounted to said impeller shaft on a common plane wherein said plane is perpendicular to said impeller shaft.

18. The reactor vessel for complexecelle formation of claim 16 wherein at least two said stirrer blades are mounted to said impeller shaft not on a common plane wherein said plane is perpendicular to said impeller shaft.
